(19) United States
(12) Patent Application Publication
(10) Pub. No.: US 2026/0050085 A1
(43) Pub. Date: Feb. 19, 2026

(54) LIDAR SYSTEMS AND METHODS

(71) Applicant: NEYE SYSTEMS, INC., Emeryville, CA (US)

(72) Inventors: Xiaosheng ZHANG, Davis, CA (US); Tae Joon SEOK, El Cerrito, CA (US); Kyungmok KWON, El Cerrito, CA (US); Noriaki KANEDA, Westfield, NJ (US); Ming Chiang A. WU, Piedmont, CA (US)

(21) Appl. No.: 19/104,521

(22) PCT Filed: Aug. 18, 2023
(86) PCT No.: PCT/US2023/072487

§ 371 Date: Feb. 18, 2025

Related U.S. Application Data
(60) Provisional application No. 63/371,857, filed on Aug. 18, 2022.

(51) Int. Cl. G01S 17/894; G01S 7/481; G01S 7/4865

(52) U.S. Cl. CPC G01S 17/894; G01S 7/4816; G01S 7/4865

(57) ABSTRACT

The present disclosure is directed to imaging LiDARs that can include a FPSA beam scanner and a time of flight (ToF) detector array. The ToF detector array may comprise an array of single-photon avalanche diodes (SPADs), or an array of avalanche photodiodes (APDs). In one aspect, the ToF detector arrays are disposed on a CMOS integrated circuit wafer, wherein each of the ToF detectors is configured to receive reflected light from the target through a corresponding optical antenna. Methods of use are also provided.

### PRIORITY CLAIM

This patent application claims priority to U.S. provisional patent application No. 63/371,857, titled “LIDAR SYSTEMS AND METHODS”, and filed on Aug. 18, 2022, which is herein incorporated by reference in its entirety.

### FIELD

The present disclosure details novel LiDAR systems and methods. More specifically, this disclosure is directed to imaging LiDARs.

### BACKGROUND

Light detection and ranging (LiDAR) is widely used in autonomous vehicles and portable devices such as smartphones and tablets. Solid state LiDARs are particularly attractive because they are conducive to miniaturization and mass production. US Patent Pub. No. 2021/0116778 teaches a beamsteering system consisting of a programmable array of vertical couplers (also called optical antennas) located at the focal plane of an imaging lens. Optical signals can be delivered to any selected optical antenna through a programmable optical network consisting of MEMS (micro-electro-mechanical system)-actuated waveguide switches. Compared with conventional thermo-optic or electro-optic switches, the MEMS switches offer lower insertion loss, lower crosstalk, broadband operation, and digital actuation. High density arrays of programmable optical antennas can be integrated on single chips for high resolution imaging LiDARs, thanks to their small footprint.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A-1C show schematics of a LiDAR system with a FPSA beam scanner and a ToF detector array receiver.

FIGS. 2A-2C show cross-sectional view schematics of the LiDAR systems of FIGS. 1A-1C, with a FPSA beam scanner and a ToF detector array receiver.

FIGS. 3A-3B show a schematic of a pseudo-monostatic LiDAR system with FPSA and monolithically integrated detectors.

FIG. 4 shows a schematic of a pseudo-monostatic LiDAR system with an FPSA and a stacked detector array.

FIGS. 5A-5C and 6A-6B show schematics of pseudo-monostatic LiDAR systems with an FPSA and a stacked detector array where a quarter wave plate is inserted in the light path, so that the returned light can pass through the transmitting antenna(s) without absorption losses.

### SUMMARY

An imaging LiDAR system is provided, comprising a light source; a focal plane switch array (FPSA) beam scanner comprising an array of optical antennas, the FPSA beam scanner being optically coupled to the light source and configured to transmit light towards a target with at least one of the optical antennas; and a time of flight (ToF) detector array configured to receive reflected light from the target.

In some aspects, the ToF detector array comprises an array of single-photon avalanche diodes (SPADs).

In another aspect, the ToF detector array comprises an array of avalanche photodiodes (APDs).

In some aspects, the FPSA beam scanner and ToF detector array have an identical pixel count.

In one aspect, a pixel count of the FPSA beam scanner and ToF detector array is different.

In some aspects, the FPSA beam scanner is configured to transmit light through a first lens and the ToF detector is configured to receive reflected light through a second lens.

In another aspect, the FPSA beam scanner and the ToF detector array transmit and receive light through a shared lens.

In another aspect, the system includes a beam splitter configured to reflect the received light towards the ToF detector array. In some aspects, the beam splitter comprises a polarization beam splitter.

In one aspect, the system includes a polarization rotator configured to rotate a polarization direction of the received light such that all received light can be reflected by the polarization beam splitter. In another aspect, the polarization rotator comprises a quarter wave plate configured to rotate the received light by approximately 90 degrees.

In some aspects, a plurality of the optical antennas are configured to transmit light in multiple directions simultaneously. In some aspects, the reflected light is focused on different pixels of the ToF detector array to detect multiple targets simultaneously.

An imaging LiDAR system is provided, comprising: a light source; a focal plane switch array (FPSA) beam scanner comprising an array of optical antennas and an array of monolithically integrated time of flight (ToF) detectors, the FPSA beam scanner being optically coupled to the light source and configured to transmit light towards a target with at least one of the optical antennas and receive reflected light from the target with a corresponding at least one of the ToF detectors.

In some aspects, the ToF detectors comprise single-photon avalanche diodes (SPAD).

In other aspects, the ToF detectors comprise avalanche photodiodes (APD).

In one aspect, the optical antennas and ToF detectors are arranged in adjacent pairs.

In some aspects, the optical antennas and the ToF detectors transmit and receive light through a shared lens.

An imaging LiDAR system is provided, comprising: a light source; a focal plane switch array (FPSA) comprising an array of optical antennas, the FPSA beam scanner being optically coupled to the light source and configured to transmit light towards a target with at least one of the optical antennas; a complementary metal-oxide semiconductor (CMOS) integrated circuit wafer disposed adjacent to the FPSA; an array of time of flight (ToF) detectors disposed on the CMOS integrated circuit wafer, wherein each of the ToF detectors is configured to receive reflected light from the target through a corresponding optical antenna.

In some aspects, each of the optical antennas has a corresponding ToF detector.

In one aspect, the system further includes a lens.

In one aspect, the system includes a quarter wave plate disposed between the FPSA and the lens.

In another aspect, the system includes a quarter wave plate disposed above the lens.

In some aspects, the system further comprises a quarter wave plate integrated or stacked with a micro lens array.

In another aspect, the system includes a polarization selective reflector disposed between the FPSA and the array of ToF detectors.

In one aspect, the polarization selective reflector is configured to reflect light with a polarization direction the same as the transmitted light and allow light with a polarization direction orthogonal to the transmitted light to pass.

In some aspects, a top surface of the quarter wave plate is coated to be partially reflective to generate local oscillator (LO) light.

### DETAILED DESCRIPTION

This disclosure provides LiDAR systems and methods with receiver configurations using a Focal Plane Switch Array (FPSA) as the transmitter (beam scanner). Embodiments disclosed herein can include:
(1) A time-of-flight (ToF) LiDAR with a FPSA transmitter and ToF detector array (single photon avalanche detector (SPAD) array, avalanche photodiode (APD) array, etc.).
(2) A pseudo-monostatic ToF LiDAR with a FPSA transmitter and monolithically integrated detectors (single SPAD, APD, etc.).
(3) A pseudo-monostatic ToF LiDAR with a FPSA transmitter and a stacked detector array (SPAD, APD, etc.).
(4) A pseudo-monostatic coherent LiDAR with a FPSA transmitter and stacked detector array (p-i-n photodiode, etc.), and with reflected free-space light as the local oscillator light.

This disclosure provides more flexible uses of FPSA beam steering technology. The FPSA can be used in LiDAR system with different ranging principles (ToF, coherent, etc.) and different types of detectors (SPAD, APD, p-i-n, etc.).

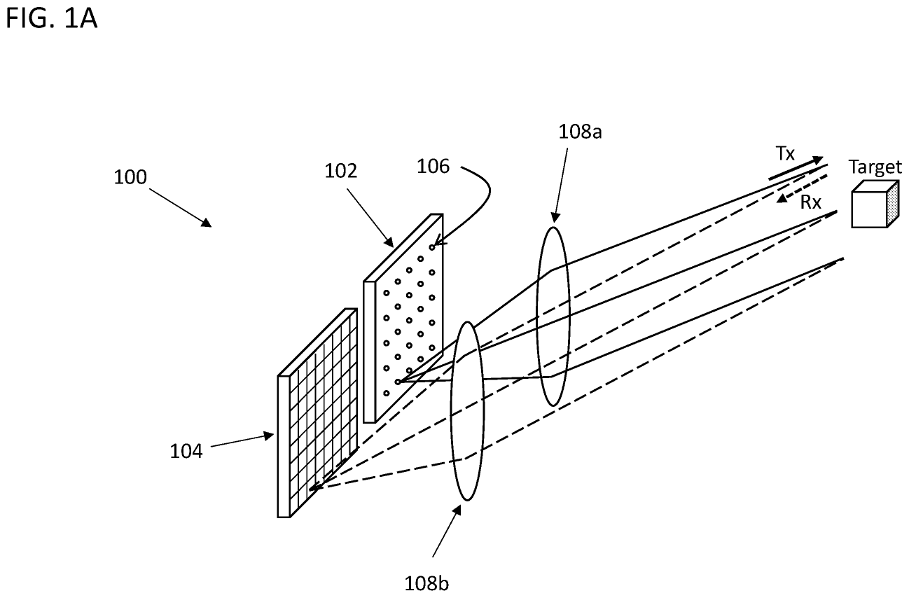

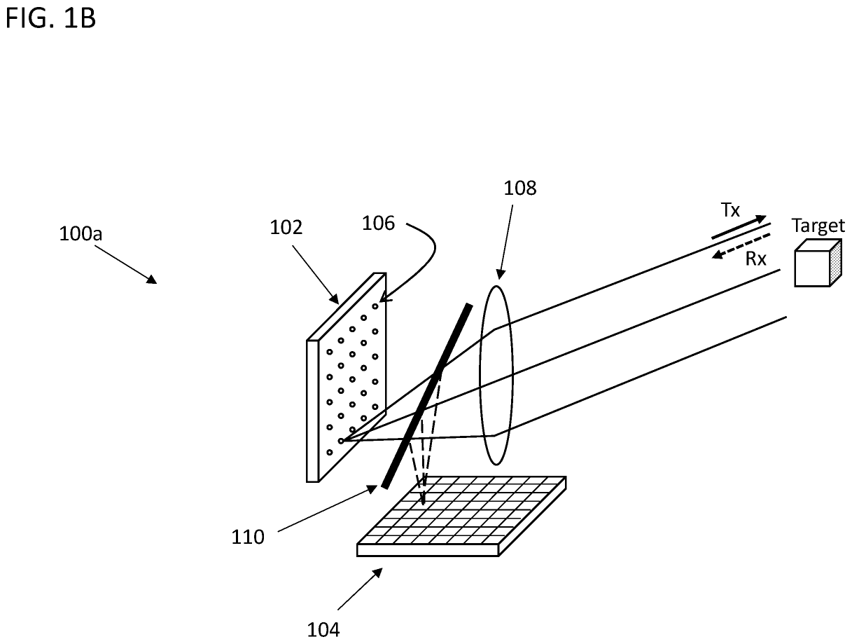

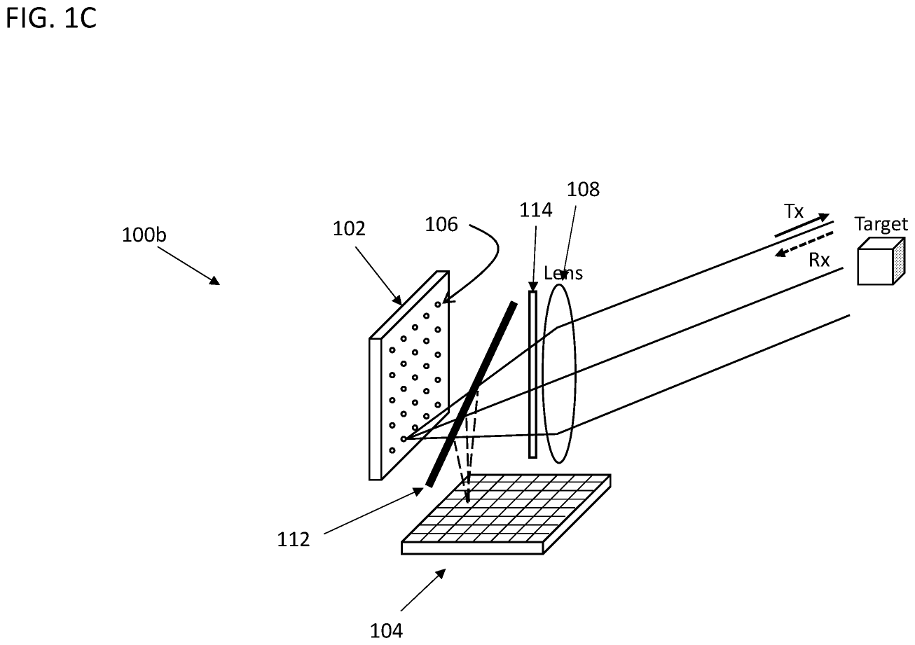

FIGS. 1A-1C show various implementations of a LiDAR system 100 that includes a FPSA beam scanner 102 as a transmitter and a ToF detector array 104 as a receiver. The FPSA beam scanner 102 can include a two-dimensional (2D) array of optical antennas 106 placed at the focal plane of a first imaging lens 108a. An optical switch network in the FPSA beam scanner 102 selectively activates one or more optical antennas 106 at a time. Each activated optical antenna transmits light to a certain direction (Tx) towards a Target. The ToF detector array 104 receives reflected light from the Target (Rx) through second imaging lens 108b.

The ToF detector array may include an array of single-photon avalanche diodes (SPAD), an array of avalanche photodiodes (APD), or arrays of other known detectors for ToF detection, including detectors for indirect ToF detection. The FPSA beam scanner 102 and ToF detector array 104 chips may be placed on the same plane, as shown in FIG. 1A, or on separate planes. The sizes or pixel counts of the FPSA beam scanner 102 and the ToF detector array 104 can be the same, or can be different. For example, the FPSA may have the same or more pixels than the ToF detector array, or alternatively, the ToF detector array may have more pixels.

In use, pulsed light is transmitted to the target from one or more optical antenna(s) 106 of the FPSA through the first lens 108a. The light pulses can be generated by a laser source that is either integrated into the FPSA or external to the FPSA. Diffuse reflected light from the target is collected by the second lens 108b and focused on the ToF detector array 104. The received pulsed light will generate an electrical signal on the corresponding ToF detector array pixel. For indirect ToF detection, the transmitted light may also be amplitude-modulated continuous-wave light.

The system may be arranged in a bistatic configuration (shown in FIG. 1A) where the FPSA beam scanner 102 and the ToF detector array 104 use different apertures or lenses 108a and 108b, or in a monostatic configuration 100a/100b (shown in FIGS. 1B and 1C) where the FPSA beam scanner 102 and ToF detector share the same lens 108. In the monostatic configuration shown in FIG. 1B, a beam splitter 110 is used to reflect the received light to the ToF detector array 104. The beam splitter can be positioned, for example, between the FPSA beam scanner and the lens 108 and/or between the ToF detector array and the lens 108. The beam splitter may also be located above the lens.

In the monostatic configuration shown in FIG. 1C, a polarization beam splitter 112 is used, and a polarization rotator or a quarter wave plate 114 is inserted to rotate the polarization direction of the received light by approximately 90 degrees from the polarization direction of the transmitted light so all received light can be reflected by the polarization beam splitter.

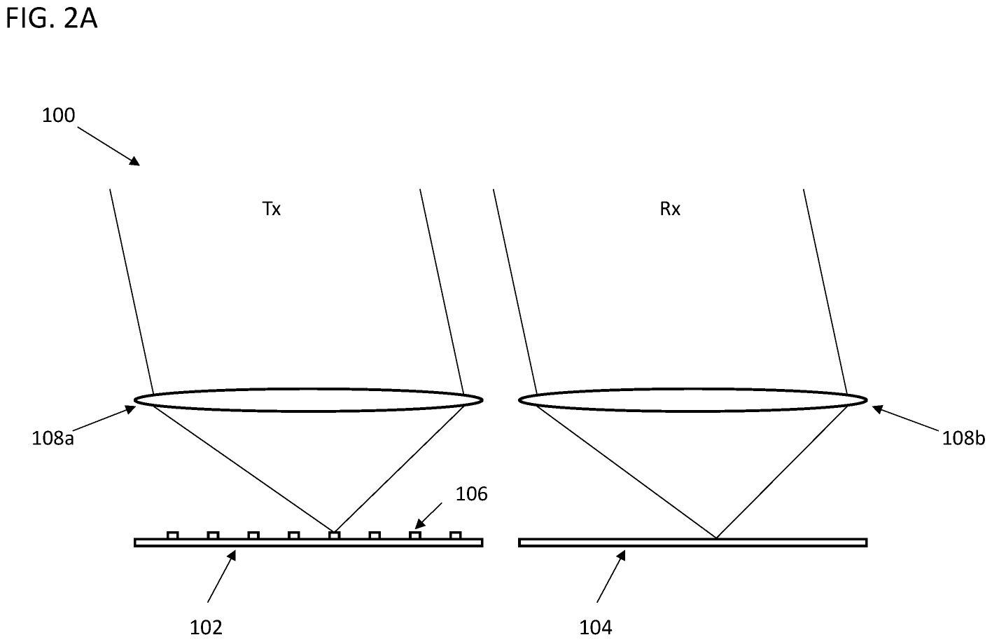

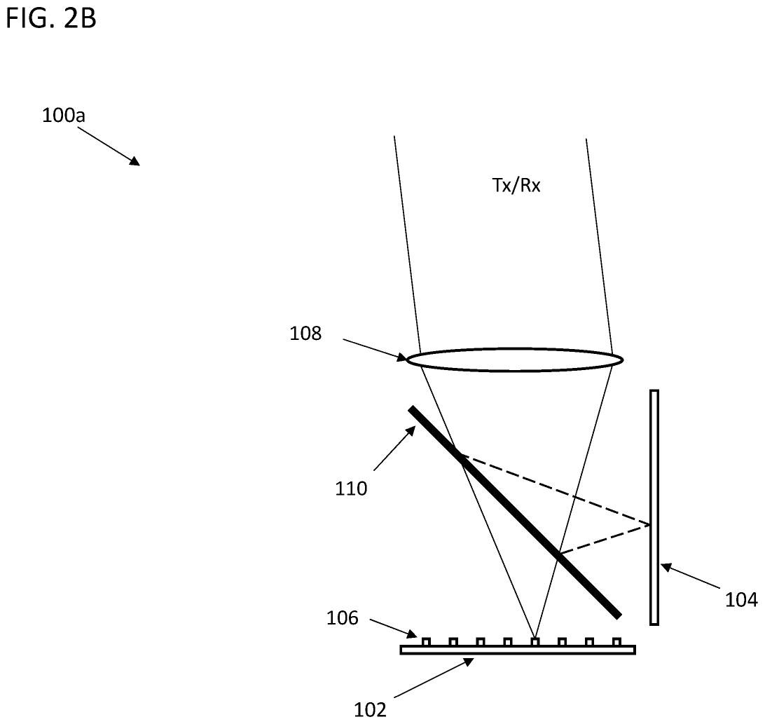

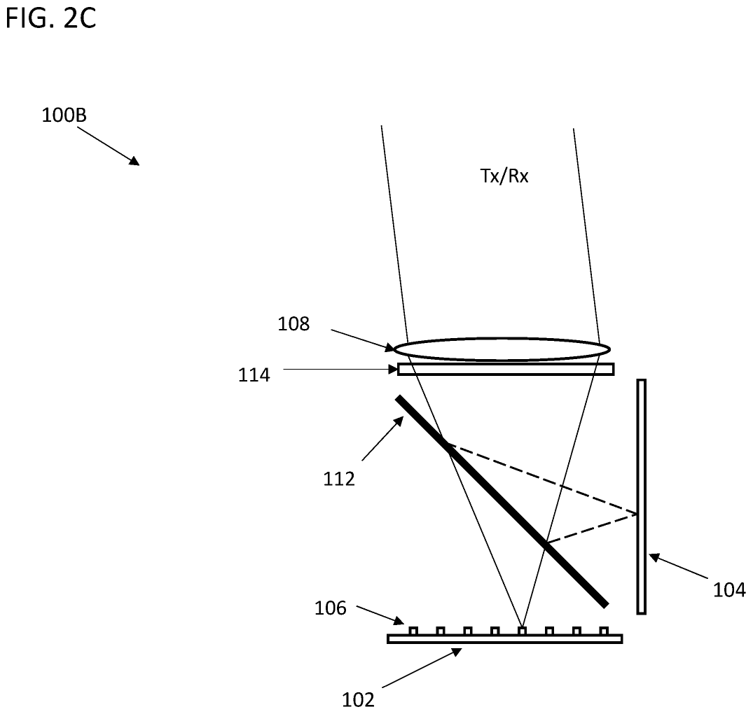

FIGS. 2A-2C show cross-sectional view schematics of the LiDAR systems of FIGS. 1A-1C, respectively, with a FPSA beam scanner 102 and a ToF detector array 104. FIG. 2A is a cross-sectional view of the system of FIG. 1A, FIG. 2B is a cross-sectional view of the system of FIG. 1B, and FIG. 2C is a cross-sectional view of the system of FIG. 1C.

In the LiDAR system shown in FIGS. 1A-1C and 2A-2C, pulsed light is sent to the target with the FPSA beam scanner 102 and the diffuse reflected light from the target is received by the ToF detector array 104 (SPAD array, APD array, etc.). An electrical signal will be generated by the corresponding ToF detector pixel, and the time difference between the transmitted light pulse and the received light pulse can be detected by a time-to-digital converter. Then the target distance can be calculated. For indirect ToF detection, the transmitted light may also be amplitude-modulated continuous-wave light, and the time difference between transmitted and received light may be detected by the phase of the amplitude modulation envelope. Electronics including one or more processors may be coupled to or included in the LiDAR system to perform the processing steps including evaluating the electrical signal and/or calculating the target distance.

If multiple antennas 106 on the FPSA beam scanner 102 are turned on at the same time, light will be transmitted towards multiple directions simultaneously. The returned light will be focused on different locations (pixels) of the ToF detector array, therefore multiple targets can be detected simultaneously.

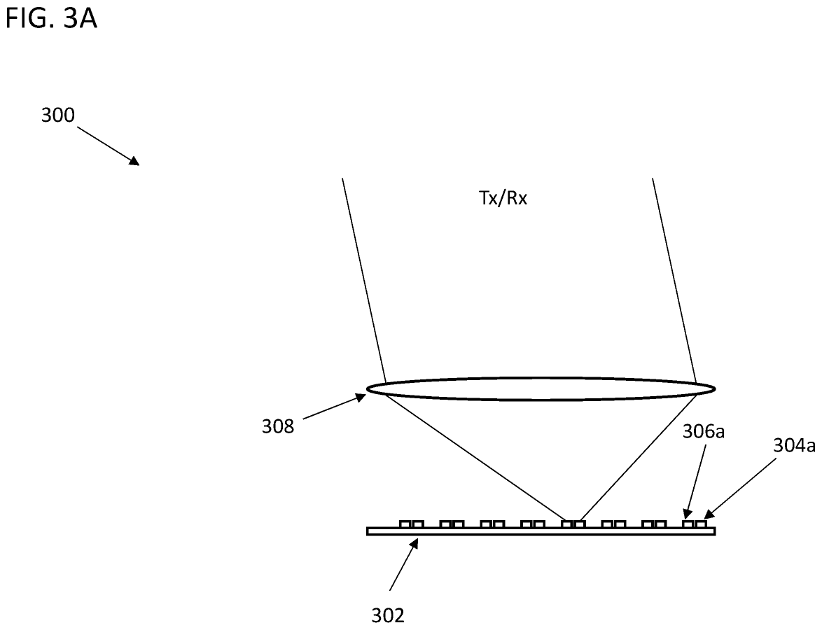

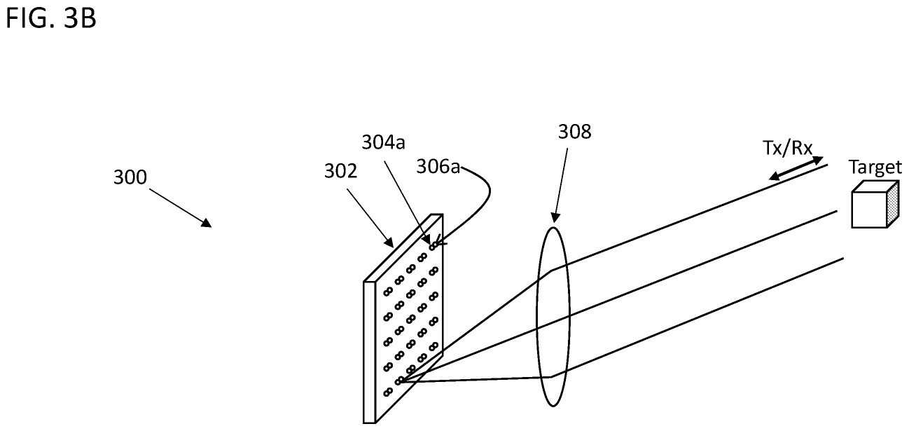

FIGS. 3A-3B show a schematic of a pseudo-monostatic LiDAR system 300 with a FPSA beam scanner that includes monolithically integrated detectors. As shown in FIGS. 3A-3B, the FPSA beam scanner 302 can include a plurality of optical antennas 306a and ToF detectors 304a. Each detector may be a single SPAD, an APD, or other known detectors for ToF detection. Each detector 304a can be integrated adjacent to a transmit optical antenna 306a on the FPSA beam scanner 302. Light is transmitted from one or multiple optical antenna(s) 306a to a target (not shown) and then light returned from the target will be received by the corresponding detector(s) 304b.

In the LiDAR system shown in FIGS. 3A-3B, pulsed light is sent to the target from a light source (laser source) and one or multiple optical antenna(s) 306a, and the diffuse reflected light from the target is received by the corresponding adjacent detector(s) 304a. Electrical signals will be generated on the corresponding detector(s), and the time difference between the transmitted light pulses and the received light pulses can be detected by a time-to-digital converter. Then the target distance can be calculated. As described above, the electronics and processors such as the time-to-digital converter can be integrated into the FPSA or simply electrically connected to the system.

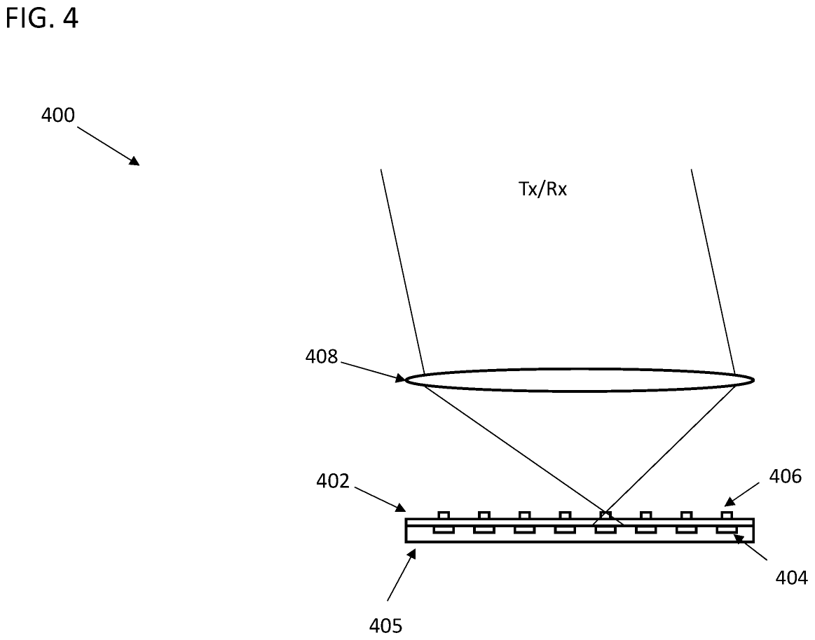

FIG. 4 shows a schematic of a pseudo-monostatic LiDAR system 400 with an FPSA 402 and a stacked ToF detector array 404. The detector array 404 may be on a CMOS integrated circuit wafer 405, which can also serve as the FPSA controller, detector amplifier, and data processing circuits. Each FPSA antenna 406 has a corresponding detector 405 underneath it. The detectors can be SPAD, APD, p-i-n photodiode, or other known types of photo detectors. Light is transmitted from one or multiple FPSA antenna(s) 406 toward a target (not shown) and then light is returned from the target to pass through the transmitting antenna(s) and be received by the corresponding detector(s) 404.

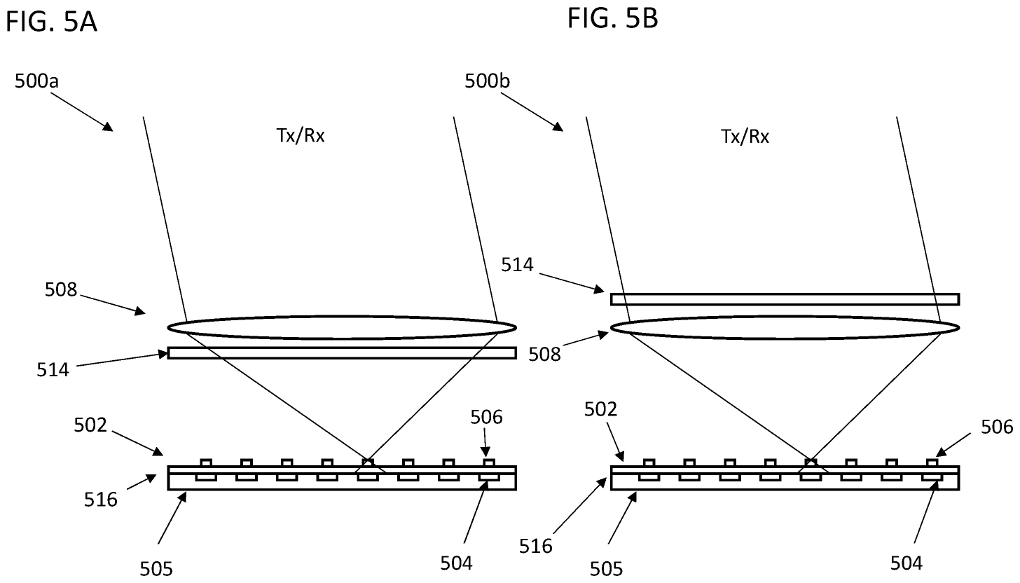

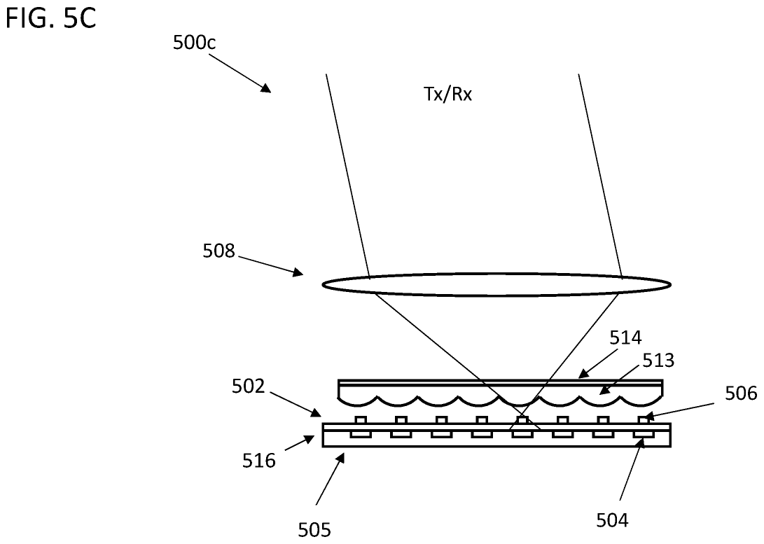

In the embodiment of FIG. 4, if the returned light has the same polarization as the transmitted light, the transmitting antenna will absorb part of the returned light, which reduces the optical power on the bottom detectors 404. In FIGS. 5A-5C, a similar system to the one of FIG. 4 is shown, including a FPSA 502, stacked ToF detector array 504 on a CMOS wafer 505, and a lens 508. In these embodiments, a quarter wave plate (QWP) 514 can be inserted in the light path, so the returned light has orthogonal polarization direction compared with the transmitted light. Therefore, the returned light can pass through the transmitting antenna(s) 506 without absorption losses. The QWP 514 may be inserted in between the FPSA chip and the lens (as shown in system 500a in FIG. 5A), or above the lens (as shown in system 500b in FIG. 5B). The QWP 514 may also be integrated or stacked with a microlens array 513 (as shown in system 500c in FIG. 5C).

In practical situations, there will be residual transmitted light coupling directly to the detector, which can be used as local oscillator (LO) light for a coherent LiDAR system.

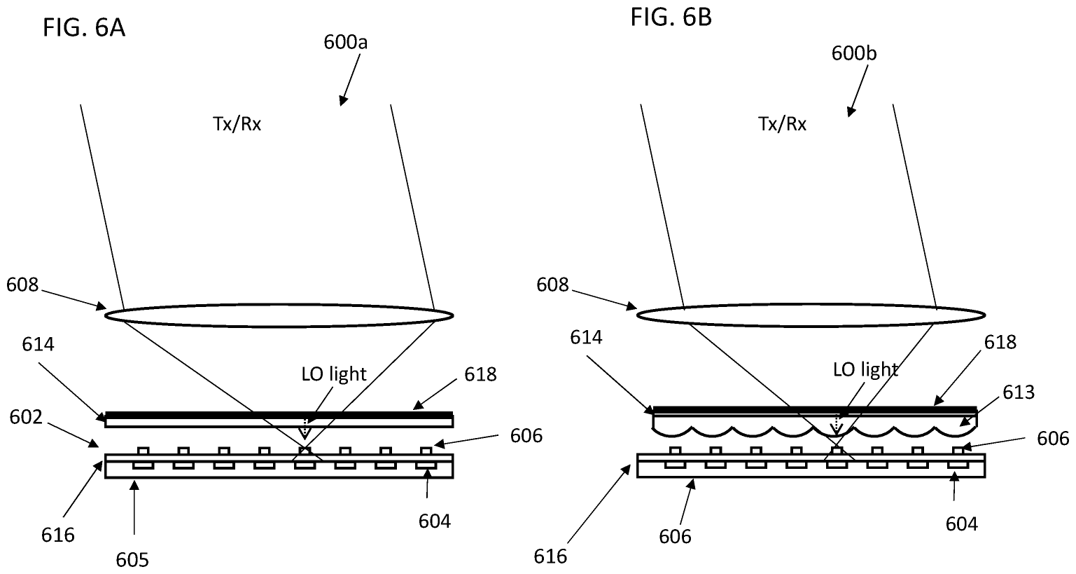

As a more controlled way to supply LO light in a coherent LiDAR system, the top surface of the QWP can be coated to be partially reflective, and the reflected light back to the detector can serve as the local oscillator light, as shown in FIGS. 6A-6B. The systems 600a and 600b of FIGS. 6A and 6B, respectively, can include the same components as the systems of FIGS. 5A-5C, including a FPSA 602, ToF detector array 604 on a CMOS wafer 605, a lens 608, and QWP 614. The reflective coating is shown as reference number 618. The QWP may be inserted in between the FPSA chip and the lens (as shown in system 600a in FIG. 6A). The QWP may also be integrated or stacked with a microlens array 613 (as shown in system 600b in FIG. 6B)

In FIGS. 5A-5C and 6A-6B, a polarization selective reflector 516/616 may be added in between the FPSA and the detector array, so that light with a polarization direction same as the transmitted light is reflected, while light with a polarization direction orthogonal to the transmitted light can pass through. This will block any residual coupling (crosstalk) from the FPSA antenna directly to the detector.

The LiDAR systems shown in FIGS. 4, 5A-5C, and 6A-6B can be configured as a ToF LiDAR or as coherent LiDAR. In the ToF LiDAR configuration, the system works similar to the ToF LiDAR shown in FIGS. 3A-3B. In the coherent LiDAR configuration, frequency-modulated continuous-wave light, random-modulated continuous-wave light, or light signal based on other known types of coherent LiDAR principles is sent to the target from one or multiple FPSA antenna(s), and the diffuse reflected light from the target is received by the corresponding adjacent detector(s). The local oscillator (LO) light of the coherent LiDAR may be from the top surface reflection of the QWP (as shown in FIGS. 6A-6B), or the residual light coupling (crosstalk) from the FPSA antenna to the detector array. The LO and returned light from the target (not shown) have the same polarization direction. Electrical signals will be generated on the corresponding detector(s), and the target distances (and velocities) can be calculated from the received electrical signals.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. An imaging LiDAR system comprising:
a light source;
a focal plane switch array (FPSA) beam scanner comprising an array of optical antennas, the FPSA beam scanner being optically coupled to the light source and configured to transmit light towards a target with at least one of the optical antennas;
a time of flight (ToF) detector array configured to receive reflected light from the target.

2. The system of claim 1, wherein the ToF detector array comprises an array of single-photon avalanche diodes (SPADs).

3. The system of claim 1, wherein the ToF detector array comprises an array of avalanche photodiodes (APDs).

4. The system of claim 1, wherein the FPSA beam scanner and ToF detector array have an identical pixel count.

5. The system of claim 1, wherein a pixel count of the FPSA beam scanner and ToF detector array is different.

6. The system of claim 1, wherein the FPSA beam scanner is configured to transmit light through a first lens and the ToF detector is configured to receive reflected light through a second lens.

7. The system of claim 1, wherein the FPSA beam scanner and the ToF detector array transmit and receive light through a shared lens.

8. The system of claim 7, further comprising a beam splitter configured to reflect the received light towards the ToF detector array.

9. The system of claim 8, wherein the beam splitter comprises a polarization beam splitter.

10. The system of claim 9, further comprising a polarization rotator configured to rotate a polarization direction of the received light such that all received light can be reflected by the polarization beam splitter.

11. The system of claim 10, wherein the polarization rotator comprises a quarter wave plate configured to rotate the received light by approximately 90 degrees.

12. The system of claim 1, wherein a plurality of the optical antennas are configured to transmit light in multiple directions simultaneously.

13. The system of claim 12, wherein the reflected light is focused on different pixels of the ToF detector array to detect multiple targets simultaneously.

14. An imaging LiDAR system comprising:
a light source;
a focal plane switch array (FPSA) beam scanner comprising an array of optical antennas and an array of monolithically integrated time of flight (ToF) detectors, the FPSA beam scanner being optically coupled to the light source and configured to transmit light towards a target with at least one of the optical antennas and receive reflected light from the target with a corresponding at least one of the ToF detectors.

15. The system of claim 14, wherein the ToF detectors comprise single-photon avalanche diodes (SPAD).

16. The system of claim 14, wherein the ToF detectors comprise avalanche photodiodes (APD).

17. The system of claim 14, wherein the optical antennas and ToF detectors are arranged in adjacent pairs.

18. The system of claim 14, wherein the optical antennas and the ToF detectors transmit and receive light through a shared lens.

19.-29. (canceled)
